(19) United States
(12) Patent Application Publication
(10) Pub. No.: US 2025/0271937 A1
(43) Pub. Date: Aug. 28, 2025

(54) System and method for non-obstructive electro-tactile stimulation of the palmar hand

(71) Applicant: THE UNIVERSITY OF CHICAGO, Chicago, IL (US)

(72) Inventors: Pedro Lopes, Chicago, IL (US); Yudai Tanaka, Chicago, IL (US)

(21) Appl. No.: 19/060,937

(22) Filed: Feb. 24, 2025

Related U.S. Application Data
(60) Provisional application No. 63/558,976, filed on Feb. 28, 2024.

(51) Int. Cl. G06F 3/01

(52) U.S. Cl. CPC G06F 3/016; G06F 3/014

(57) ABSTRACT

Systems and methods are provided for providing electro-haptic stimulation to the palmar side of the hand without encumbering the hand, permitting a wearer to interact with objects normally while also receiving electro-haptic stimuli. This is accomplished by taking advantage of the higher threshold of stimulation needed to excite dorsal nerves of the hand relative to the palmar nerves of the hand, applying stimulating electrodes to the dorsal side of the hand and providing stimulation therethrough that is sufficient to elicit stimulation (and thus perceived haptic stimuli) of nerves in the palmar skin of the hand without stimulating nerves of the dorsal skin of the hand. Multiple electrodes can be provided to each finger, allowing for electro-haptic stimulation to be delivered to multiple different locations of each finger. The polarity of the stimulation can be controlled to deliver stimuli proximal or distal to a particular electrode.

### CROSS-REFERENCE TO RELATED APPLICATION

This application claims priority to U.S. Provisional Patent Application No. 63/558,976, filed on Feb. 28, 2024, the contents of which are hereby incorporated by reference in their entirety.

### STATEMENT REGARDING FEDERALLY SPONSORED RESEARCH OR DEVELOPMENT

This invention was made with government support under 2047189 awarded by the National Science Foundation. The government has certain rights in the invention.

### BACKGROUND

It is desirable to provide human-computer interfaces (HCI) that are able to address all of the human senses, thereby bringing all the senses into, e.g., interactive experiences. Accordingly, it is desirable for haptic devices be limited not only to fingerpads but to extend to the whole of the hand, which is the primary means of interaction with the environment. In fact, even an interaction as mundane as “pressing a button” is improved if the haptic feedback extends to the whole hand. To this end, many haptic devices have been created that can render contact, texture, or force to many locations of the user's palm. These devices achieve their spatial fidelity by attaching many actuators directly to the part of the user's hand that they are meant to stimulate.

However, this approach to realizing a full-hand tactile interface comes with a major limitation. Placing the actuators directly on the user's palmar skin prevents using these tactile haptic devices beyond purely virtual interactions. In other words, these actuators prevent or otherwise impair the user's palms from feeling haptic feedback from the actual physical environment (e.g., an object being grasped), limiting the ability to grab or finely manipulate such objects-preventing the usage of such tactile devices in many interactive situations, such as mixed reality.

To address this key issue, some systems employ thin haptic actuators that allow the user to feel-through to physical objects to some degree. However, the user still feels these thin actuators between their fingerpads and the physical world, resulting in a decreased sensation of textured surfaces. A second option is to use foldable actuators that keep the user's fingerpad or palms free. Such devices fold the actuators away from the palm or the fingerpad when the users are not interacting with virtual objects. However, these are still limited in size (e.g., folding is accomplished with bulky mechanical actuators, which still impair dexterity as they occupy much of the sides and back of fingers/hands) and with respect to application domain (e.g., preventing tactile augmentation of real objects). In yet another example, electro-tactile stimulation may be provided by electrodes located on the palmar aspect of the middle and proximal phalanges of the index finger—unfortunately, these electrodes are still on the palmar side, and thus impair interaction with ‘real’ objects. Even a single electrode on any part of the palm will diminish manual dexterity. This is because manual activities involve the whole hand, and dexterity builds on the sensory image of the entire palmar side synthesizing each part's sensation.

### SUMMARY

In a first aspect, a method is provided that includes: (i) applying a set of electrodes to a wearer, wherein applying the set of electrodes comprises applying a first stimulation electrode to dorsal skin of a first finger of a hand of the wearer and applying a first return electrode to skin of the wearer; and (ii) applying stimulation through the first stimulation electrode, using the first return electrode as a counter electrode, sufficient to induce a perceivable haptic stimulus in palmar skin of the first finger of the hand without inducing a perceivable haptic stimulus in dorsal skin of the first finger of the hand.

In a second aspect, a system is provided that includes: (i) a first stimulation electrode configured to be applied to dorsal skin of a first finger of a hand of a wearer; (ii) a first return electrode configured to be applied to skin of the wearer; (iii) a stimulus generator operably coupled to the first stimulation electrode and the first return electrode; and (iv) a controller configured to operate the stimulator to apply stimulation through the first stimulation electrode, using the first return electrode as a counter electrode, sufficient to induce a perceivable haptic stimulus in palmar skin of the first finger of the hand without inducing a perceivable haptic stimulus in dorsal skin of the first finger of the hand.

In a third aspect, a non-transitory computer readable medium is provided having stored thereon program instructions executable by at least one processor to cause the at least one processor to perform the method of the first aspect.

In a fourth aspect, system is provided that includes: (i) a controller comprising one or more processor, and (ii) a non-transitory computer readable medium having stored thereon program instructions executable by the controller to cause the controller to perform the method of the first aspect.

### BRIEF DESCRIPTION OF THE DRAWINGS

The accompanying drawings are included to provide a further understanding of the system and methods of the disclosure and are incorporated in and constitute a part of this specification. The drawings illustrate one or more embodiment(s) of the disclosure, and together with the description serve to explain the principles and operation of the disclosure.

FIG. 1A depicts aspects of a hand.

FIG. 1B depicts aspects of operation of a set of electrodes to provide stimulation to the hand of FIG. 1A, according to example embodiments.

FIG. 1C depicts aspects of operation of a set of electrodes to provide stimulation to the hand of FIG. 1A, according to example embodiments.

FIG. 2A depicts aspects of a finger.

FIG. 2B depicts aspects of operation of a set of electrodes to provide stimulation to the finger of FIG. 2A, according to example embodiments.

FIG. 2C depicts aspects of operation of a set of electrodes to provide stimulation to the finger of FIG. 2A, according to example embodiments.

FIG. 3 depicts aspects of an example system.

FIG. 4 depicts aspects of an example method.

FIG. 5 depicts aspects of an example system.

FIG. 6 depicts aspects of an example system.

FIG. 7 depicts aspects of an example system.

FIG. 8 depicts experimental results.

FIG. 9A depicts experimental results.

FIG. 9B depicts experimental results.

FIG. 10 depicts experimental results.

FIG. 11 depicts experimental results.

FIG. 12 depicts experimental results.

FIG. 13 depicts experimental results.

### DETAILED DESCRIPTION

The following detailed description describes various features and functions of the disclosed embodiments with reference to the accompanying figures. The illustrative embodiments described herein are not meant to be limiting. It may be readily understood that certain aspects of the disclosed embodiments can be arranged and combined in a wide variety of different configurations, all of which are contemplated herein.

### I. OVERVIEW

It is desirable in a variety of applications to provide haptic feedback to a wearer's skin. This can include using electrical stimulators, vibrator motors, heaters, mechanical actuators, or other types of devices to provide the sensation of force, pressure, vibration, texture, heat, or other haptic stimuli. Such haptic stimuli may be provided as part of user interface, as part of a virtual reality system, as part of an augmented reality system, or as part of some other system or application. Such haptic stimuli can be provided to any part of a wearer's skin, e.g., to the fingers, palm, or other parts of the wearer's hand(s).

However, it is difficult to provide such haptic stimuli without interfering with the wearer's ability to interact with their environment in a normal and unencumbered manner. This is because many prior methods for providing such stimulation include placing some apparatus (e.g., electrodes, vibrator motors) on the skin to be stimulated. Accordingly, this apparatus intrudes between the wearer's skin and their environment. This is particularly cumbersome for the hands, where haptic sensitivity and dexterity are at their highest; even very thin, flexible stimulation electrodes can negatively impact functional dexterity and reduce tactile sensitivity to texture and other tactile information.

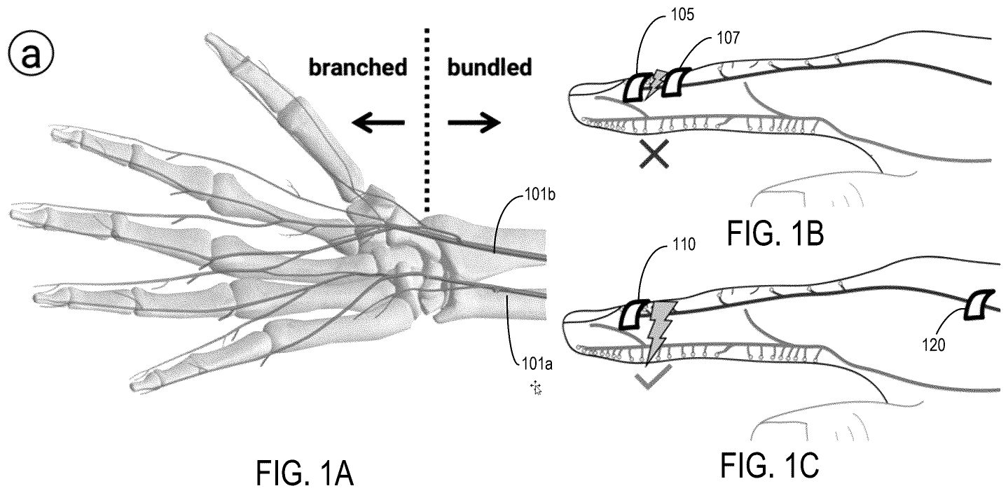

Attempts to provide electro-haptic stimulation via electrodes applied to the wrist or forearm (and thus away from the hands, to avoid impeding the use of the hands to interact with the environment) result in stimuli that are not distinguishable between fingers, due to the proximity of the nerve fibers for the different fingers within the nerves of the wrist and forearm. FIG. 1A illustrates the relevant anatomy; by the point that the electrodes would avoid encumbering use of the hands (the dashed line, at the wrist), the nerve fibers for the individual fingers have already bundled together into the few large nerves of the wrist (e.g., the ulnar 101a and median 101b nerves), making it difficult or impossible to stimulate the fibers of individual fingers using stimulation delivered from outside the skin.

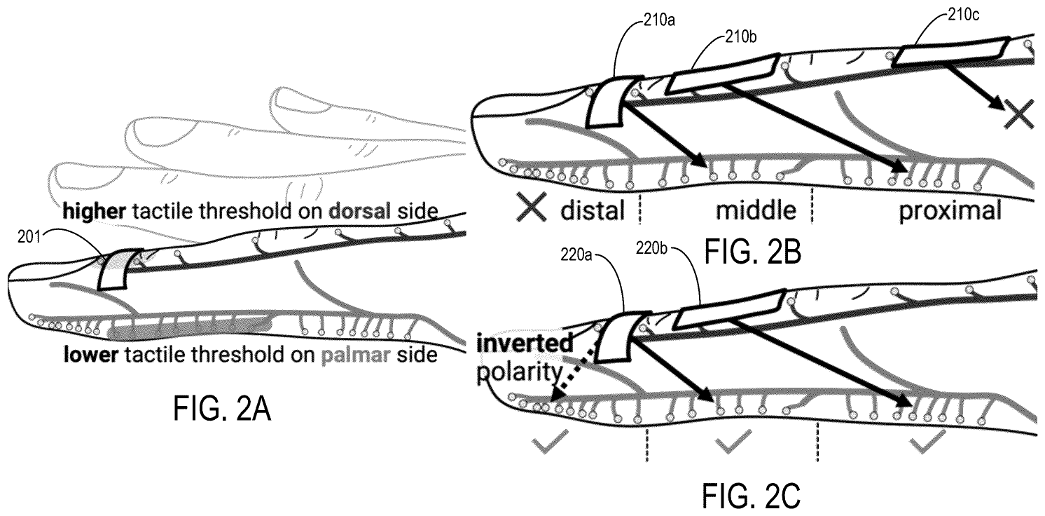

The embodiments described herein provide improvements to the above limitations, allowing finger-specific electro-haptic stimulation to be delivered using electrodes applied to the dorsal (back) skin of the hand. Such electrodes, being applied to the dorsal side of the hand, do not interfere with the majority of the uses of the hands to interact with the environment, e.g., to grasp objects, feel objects, manipulate objects, push objects, or otherwise interact with the environment using the palmar surfaces of the hand. This arrangement (i.e., the use of stimulation electrodes applied to the dorsal skin of the hand to deliver perceivable stimulation of the palmar skin of the hand) is made possible by the relatively much greater sensitivity of the palmar skin than the dorsal skin of the hand. Thus, it is possible to deliver stimulating currents/voltages via an electrode on the back (dorsal) skin of the hand that results in a wearer perceiving stimulation of the front (palmar) skin and not the back skin. FIG. 2A illustrates this relative sensitivity, which is owed in part to the much higher density of touch receptors in the palmar skin compared to the dorsal skin.

To ensure that stimulation provided via dorsal-side stimulation electrodes is able to induce perceptions in palmar skin, the return electrode for such dorsal-side stimulation electrodes can be located at a sufficient distance therefrom, e.g., at the base of the finger, or on the base of the hand (e.g., opposite from the palm of the hand). FIG. 1B illustrates a scenario wherein such spacing is not provided; the proximity of the dorsal-side stimulation 105 and return 107 electrodes result in the injected current not having a significant effect on palmar-skin nerve fibers. In contrast, FIG. 1C shows a stimulation electrode 110 on the finger with a return electrode 120 sufficiently spaced therefrom, on the dorsal side of the base of the hand, that the stimulation electrode 110 is able to stimulate palmar-skin nerve fibers and thus induce a haptic perception in the palmar skin of the finger.

Anodic or cathodic stimulation can be provided via dorsal-side stimulation electrodes. Anodic stimulation from a dorsally-applied stimulation electrode results in stimulation of nerves in the palmar skin proximal to the location of the stimulation electrode; this is illustrated in FIGS. 2A and 2B. It may be difficult to provide stimulation to the fingertips using anodic stimulation (e.g., due to the lower conductivity of the fingernail). Instead, cathodic stimulation can be provided. Cathodic stimulation from a dorsally-applied stimulation electrode results in stimulation of nerves in the palmar skin distal to the location of the stimulation electrode. In this way, an electrode applied proximal to the fingernail can be used to provide electrohaptic stimulation to the fingertip. Additionally or alternatively, a single stimulation electrode can be used to provide electrohaptic stimulation to two different locations of the palmar skin, one location distal and one location proximal to the location of the stimulation electrode. This is illustrated in FIG. 2C, where a first stimulation electrode 220a is used to provide stimulation to the fingertip (by providing cathodic stimulation) and alternatively to the middle finger segment (by providing anodic stimulation). Stimulation to the remaining proximal-most base segment of the finger is provided by a second stimulation electrode 220b providing anodic stimulation.

Note that stimulation being ‘anodic’ or ‘cathodic’ refers to the sign of the ‘main’ pulses of current injected via the electrode; in practice, any stimulation is likely to be charge balanced (or nearly so), with the net current injected via a particular electrode over a train of stimulation being approximately zero. In such examples, stimulation being, e.g., cathodic means that the highest-amplitude aspect of the injected current (or voltage) waveform is cathodic, with a lower-amplitude aspect being the opposite (anodic, in the example of cathodic stimulation), but of longer duration, in order to balance to total injected current to near zero, thereby avoiding oxidation or other unwanted chemical reactions at the stimulation electrode.

A variety of systems (e.g., hand-or wrist-mounted or otherwise wearable systems) can include stimulation electrode(s) configured as described herein to be applied to the dorsal skin of the hand (e.g., to the dorsal skin of the fingers or base of the hand) and used, with one or more return electrodes, by the system to deliver electro-haptic stimulation that results in a wearer perceiving haptic stimuli on the palmar skin of the hand. Such systems can include multiple stimulation electrodes applied to a single finger in order to provide stimulation to respective locations of the finger. Individual stimulation electrodes could be operated to provide stimulation to respective single locations (e.g., by providing only anodic or only cathodic stimulation therethrough) or to respective sets of two locations (e.g., by alternatingly providing both anodic and cathodic stimulation through a single stimulation electrode). Such systems could include stimulation electrodes for stimulating the fingers (e.g., the thumb, index finger, middle finger, ring finger, and/or pinky finger) and/or for stimulating other parts of the hand. For example, a system could include one or more stimulating electrodes configured to provide stimulation that results in perception of stimulus of the palmar skin of the base of the hand (which may be referred to as the “palm” of the hand). Such stimulation electrode(s) could be applied to the wrist, e.g., to the palmar skin of the wrist, allowing them to provide stimulation that results in perceived stimuli in the hand while avoiding encumbering the palmar skin of the hand.

Return electrode(s) for a system as described herein may be disposed as distances sufficiently far from corresponding stimulation electrode(s), e.g., on dorsal skin of the base of the hand. To reduce the degree to which return currents passing through the return electrode(s) case unwanted stimulation (e.g., to fingers other than the finger to which a stimulation electrode is applied), the size of the return electrode(s) can be larger than the size of the stimulation electrode(s). Additionally or alternatively, multiple return electrodes could be provided, to leverage the anatomical observation that certain fingers are served by the ulnar nerve while other fingers are served by the median nerve. Thus, a first return electrode could be placed on the lateral portion of the base of the hand, over the ulnar nerve, and a second return electrode could be placed on the medial portion of the base of the hand, over the median nerve. Currents injected through stimulation electrodes on the ulnar nerve-served fingers could be returned via the lateral first return electrode, reducing the likelihood that unwanted stimuli are perceived in the median nerve-served fingers. Conversely, currents injected through stimulation electrodes on the median nerve-served fingers could be returned via the medial second return electrode, reducing the likelihood that unwanted stimuli are perceived in the ulnar nerve-served fingers.

In an example embodiment, a system could include two or three stimulation electrodes applied to the dorsal skin of each of the index, middle, ring, and pinky finger, two stimulation electrodes applied to the dorsal skin of the thumb, and a stimulation electrode applied to the palmar skin of the wrist. The distal-most electrode on any given finger could be operated to provide cathodic stimulation, in order to induce percepts in the fingertip of the given finger. Such a system could include two return electrodes, applied to the medial and lateral aspects of the dorsal skin of the base of the hand. Each of the stimulation electrodes could be associated with a respective one (or both) of the return electrodes, such that currents injected via a particular stimulation electrode are returned via the associate return electrode, in order to reduce unwanted stimulation of other fingers by the particular stimulation electrode. For example, stimulation electrodes applied to fingers served by the ulnar nerve could be associated in this way with the return electrode applied to the lateral base of the hand, while fingers served by the median nerve could be associated in this way with the return electrode applied to the medial base of the hand.

Such a system could be tethered (e.g., to a computer, to other elements of a virtual reality system) or completely hand-, wrist-, and/or arm-mounted or otherwise be configured as a non-tethered wearable system. Such a non-tethered system could include batteries for power and wireless communications elements (e.g., one or more Bluetooth transceivers) to communicate with other systems (e.g., to receive inputs according to which to provide electrohaptic stimulation to a wearer using the various stimulation electrodes of the system). The system could include voltage regulators to generate, from a relatively lower battery voltage, higher voltages (e.g., more than 50 volts, more than 70 volts) sufficient to induce haptic perceptions in a wearer via injections of currents into the skin of the wearer. Such a system could include one or more stimulators configured to receive voltage from a voltage source, modulate that voltage source, and delivered the modulated voltage as a controlled current and/or voltage waveform through one or more stimulation electrodes to evoke an electro-haptic perception in a wearer.

A system could include a plurality of such stimulators, e.g., one stimulator for each stimulation electrode of the system. Additionally or alternatively, a system could include relatively fewer such stimulators (e.g., only a single stimulator) that is coupled to the various stimulation and/or return electrode(s) of the system via an array of electrical switches. The array of switches could be operated over time to electrically couple to the stimulator(s) to different stimulation electrodes over time, allowing a single stimulator to be used to provide stimulation to a plurality of different stimulation electrodes. The rate of switching between the stimulation electrodes could be sufficiently fast that the wearer perceives stimulation through multiple different electrodes as occurring simultaneously. Such an array of switches could also be configured to control the polarity with which the stimulator output is applied to a stimulation electrode and return electrode, allowing the array of switches to be operated to control the polarity of the delivered stimulation while allowing the stimulator to be configured to generate only a single polarity of stimulation.

A system as described herein could receive inputs or other information from a remote system and, from those inputs, determine levels of stimulation to provide via the various stimulation electrodes of the system. This could include receiving a set of stimulation magnitudes directly, or could include receiving some other information (e.g., a set of output symbols or states of a user interface) and determining therefrom a set of stimulation magnitudes (e.g., mapping a set of output symbols or states of a user interface into corresponding patterns of stimulation stored in calibration data or other local settings or information stored by the system).

In some examples, the system could include calibration data indicating the magnitude of stimulation to provide via each of the stimulation electrodes. Such calibration data could include a single stimulation magnitude for each electrode, a range of acceptable stimulation magnitudes for each electrode, or some other calibration information that could be used to generation stimulation. For example, the system could receive an input normalized stimulation magnitude and could, based on calibration data indicating a range of acceptable stimulation magnitudes, map the input normalized stimulation magnitude to the range of acceptable stimulation magnitudes and then deliver stimulation according to the mapped value.

Such calibration data could be obtained in a variety of ways. For example, stimulation at a range of magnitudes could be provided via a single stimulation electrode, with a wearer providing feedback as to whether individual magnitudes of stimulation result in perceptions in the palmar and/or dorsal skin of the corresponding body part (e.g., finger, palm of the hand). The calibration data for the single electrode could then be determined based on the wearer's feedback, e.g., a minimum stimulation magnitude set to a magnitude greater than the minimum magnitude observed to induce perceptions in the palmar skin of the hand and a maximum stimulation magnitude set to a magnitude less than the minimum magnitude observed to induce perceptions in the dorsal skin of the hand. The system could include a user interface to allow a wearer to perform such a calibration procedure (e.g., to initiate the provision of gradually increasing magnitudes of stimulation, to indicate that a particular stimulation has induced a perception in the palmar or dorsal skin); additionally or alternatively, such functionality could be provided by a remote system (e.g., an app running on a cellphone, video game console, or other computer) that is in communication with the system.

The pattern of stimulation applied via the stimulation electrodes of a system as described herein could be determined in a variety of ways. In some examples, the pattern could be determined based on a user interface scheme, e.g., to convey symbolic, timing, categorical, or other information to a wearer via patterns of electrohaptic stimulation. Additionally or alternatively, the pattern could be determined to simulate interaction with a virtual objects and/or to augment interaction with a physical object (e.g., “mixed reality”). This could include detecting the position and posture of the hand (e.g., the location and orientation of the base of the hand, and the angles of the joints of the fingers) and, based on that information, simulating the interaction between the hand and one or more virtual objects in a virtual environment. This simulated interaction (e.g., a set of stimulation locations of the hand that are in contact with the virtual object, a level of force or other simulated level of interaction with the virtual object at each stimulation location) can then be used to determine stimulation magnitudes to provide via each of the stimulation electrodes of the system. The position and posture of the hand could be detected using external systems (e.g., cameras, radar or lidar systems), the wearable system itself (e.g., an IMU of the system to detect the location and orientation of the hand and/or of segments thereof, flex sensors to detect the angle of joints of the hand), and/or a combination (e.g., active or passive markers on the wearable system detected by cameras or other sensors of an external system).

### II. EXAMPLE SYSTEMS

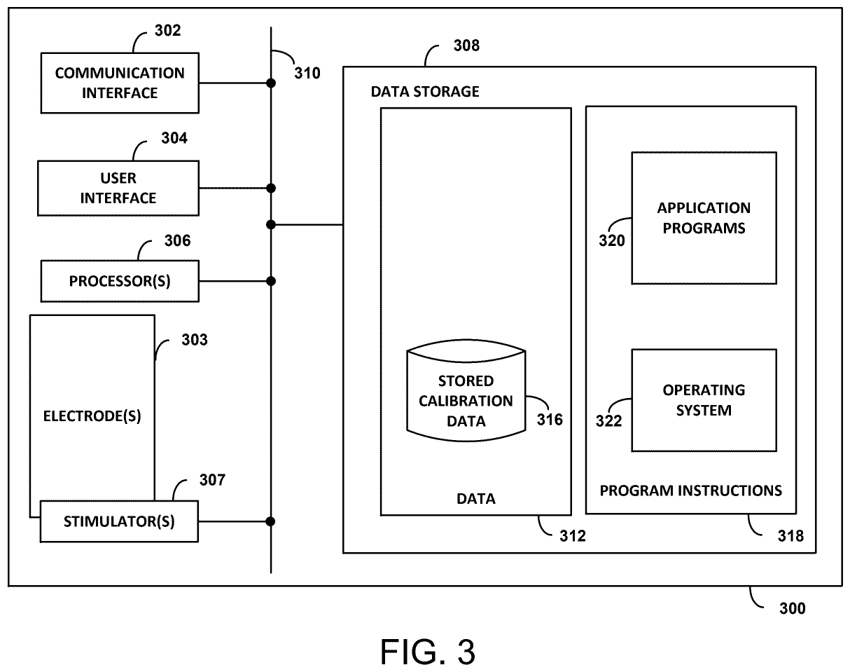

FIG. 3 illustrates an example system 300 that may be used to implement the methods and/or systems described herein. By way of example and without limitation, system 300 may be or include a computer (such as a desktop, notebook, tablet, or handheld computer, a server), elements of an wearable system (e.g., a system configured to be worn on a hand and/or wrist), elements of an assistive device, or some other type of device or system or combination of devices and/or systems. It should be understood that elements of system 300 may represent a physical instrument and/or computing device such as a server, a particular physical hardware platform on which applications operate in software, or other combinations of hardware and software that are configured to carry out functions as described herein.

As shown in FIG. 3, system 300 may include a communication interface 302, one or more electrodes 303 (e.g., stimulation electrodes configured to be applied to dorsal skin of the finger, base, wrist, or other portion of a hand, return electrodes configured to be applied to skin of the hand to provide a return path for stimulation currents injected via stimulation electrodes), a user interface 304, one or more processors 306, one or more stimulators 307, and data storage 308, all of which may be communicatively linked together by a system bus, network, or other connection mechanism 310.

Communication interface 302 may function to allow system 300 to communicate, using analog or digital modulation of electric, magnetic, electromagnetic, optical, or other signals, with other devices (e.g., with systems providing sets of haptic outputs to be delivered to a wearer of the system 300 by, e.g., simulating interaction between the wearer's hand and object(s) in a simulated environment), access networks, and/or transport networks. Thus, communication interface 302 may facilitate circuit-switched and/or packet-switched communication, such as plain old telephone service (POTS) communication and/or Internet protocol (IP) or other packetized communication. For instance, communication interface 302 may include a chipset and antenna arranged for wireless communication with a radio access network or an access point. Also, communication interface 302 may take the form of or include a wireline interface, such as an Ethernet, Universal Serial Bus (USB), or High-Definition Multimedia Interface (HDMI) port. Communication interface 302 may also take the form of or include a wireless interface, such as a WiFi, BLUETOOTH®, global positioning system (GPS), or wide-area wireless interface (e.g., WiMAX, 3GPP Long-Term Evolution (LTE), or 3GPP 5G). However, other forms of physical layer interfaces and other types of standard or proprietary communication protocols may be used over communication interface 302. Furthermore, communication interface 302 may comprise multiple physical communication interfaces (e.g., a WiFi interface, a BLUETOOTH® interface, and a wide-area wireless interface).

User interface 304 may function to allow system 300 to interact with a user, for example to receive input from and/or to provide output to the user. Thus, user interface 304 may include input components such as a keypad, keyboard, touch-sensitive or presence-sensitive panel, computer mouse, trackball, joystick, microphone, and so on. User interface 304 may also include one or more output components such as a display screen which, for example, may be combined with a presence-sensitive panel. The display screen may be based on CRT, LCD, and/or LED technologies, or other technologies now known or later developed. User interface 304 may also be configured to generate audible output(s), via a speaker, speaker jack, audio output port, audio output device, earphones, and/or other similar devices. The user interface 304 may be operable to permit a user to initiate a calibration procedure and to provide feedback related thereto (e.g., to indicate whether stimulation provided by the system provoked a haptic perception on the palmar and/or dorsal skin of the user's hand), allowing stimulation magnitude calibration data to be generated and/or input, or to perform some other operation.

Processor(s) 306 may comprise one or more general purpose processors—e.g., microprocessors-and/or one or more special purpose processors—e.g., digital signal processors (DSPs), graphics processing units (GPUs), floating point units (FPUs), network processors, tensor processing units (TPUs), or application-specific integrated circuits (ASICs). Data storage 308 may include one or more volatile and/or non-volatile storage components, such as magnetic, optical, flash, or organic storage, and may be integrated in whole or in part with processor(s) 306 and/or with some other element of the system. Data storage 308 may include removable and/or non-removable components.

Processor(s) 306 may be capable of executing program instructions 318 (e.g., compiled or non-compiled program logic and/or machine code) stored in data storage 308 to carry out the various functions described herein. Therefore, data storage 308 may include a non-transitory computer-readable medium, having stored thereon program instructions that, upon execution by system 300, cause system 300 to carry out any of the methods, processes, or functions disclosed in this specification and/or the accompanying drawings. The execution of program instructions 318 by processor(s) 306 may result in processor 306 using data 312.

By way of example, program instructions 318 may include an operating system 322 (e.g., an operating system kernel, device driver(s), and/or other modules) and one or more application programs 320 (e.g., functions for executing the methods described herein) installed on system 300. Data 312 may include stored calibration data 316 (e.g., stored sets stimulation thresholds to induce palmar and/or dorsal haptic perceptions for each electrode of the array 303) that can be used to determine how to operate the simulator(s) 307 and/or electrode(s) 303 to provide electro-haptic sensory stimulus to a user.

Application programs 320 may communicate with operating system 322 through one or more application programming interfaces (APIs). These APIs may facilitate, for instance, application programs 320 transmitting or receiving information via communication interface 302, receiving and/or displaying information on user interface 304, and so on.

Application programs 320 may take the form of “apps” that could be downloadable to system 300 through one or more online application stores or application markets (via, e.g., the communication interface 302). However, application programs can also be installed on system 300 in other ways, such as via a web browser or through a physical interface (e.g., a USB port) of the system 300.

Stimulator(s) 307 may include high voltage generators, amplifiers, switches, controlled-current and/or controlled-voltage sources, clocks, current and/or voltage-limiting elements, or other elements to controllably generate currents, voltages or other energies that can be delivered to a user's hand(s) via the electrode(s) 303. In some examples, the stimulator 307 can be configured to generate a single controlled current/voltage at a time, and to operate an array of switches to deliver that single controlled current/voltage to a specified stimulation electrode and return electrode of the electrode(s) 303, with different levels of stimulation provided via multiple different stimulation electrodes by operating the array of switches in a time-division multiplexed manner. Additionally or alternatively, the stimulator(s) 307 could include multiple stimulator systems capable of generating respective controlled currents/voltages at a time. For example, an independent stimulator system could be provided for each stimulating electrode of the system 300. Alternatively, each such independent stimulator system could be connected to a plurality of different stimulation electrodes via an array of switches. For example, a first stimulator and array of switches could be used to deliver stimulation via a first subset of stimulation electrodes on fingers served by a median nerve, with return currents through a first return electrode configured to be placed on a medial portion of the base of a wearer's hand; and a second stimulator and array of switches could be used to deliver stimulation via a second subset of stimulation electrodes on fingers served by an ulnar nerve, with return currents through a second return electrode configured to be placed on a lateral portion of the base of the wearer's hand.

### III. EXAMPLE METHODS

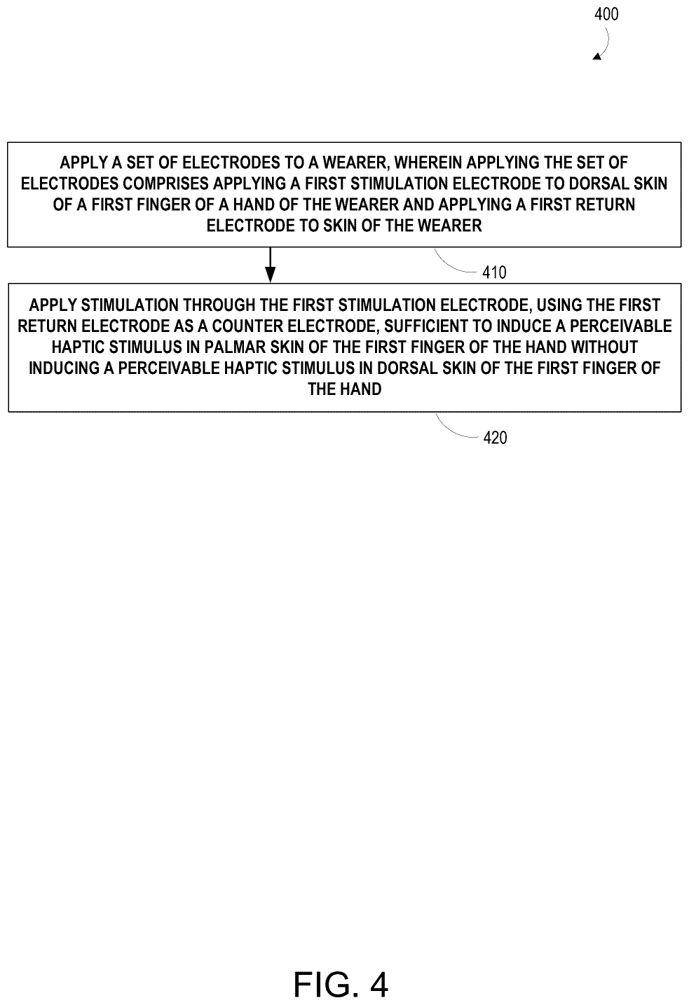

FIG. 4 depicts an example method 400. The method 400 includes applying a set of electrodes to a wearer, wherein applying the set of electrodes comprises applying a first stimulation electrode to dorsal skin of a first finger of a hand of the wearer and applying a first return electrode to skin of the wearer (410). The method 400 additionally includes applying stimulation through the first stimulation electrode, using the first return electrode as a counter electrode, sufficient to induce a perceivable haptic stimulus in palmar skin of the first finger of the hand without inducing a perceivable haptic stimulus in dorsal skin of the first finger of the hand (420). The method 400 could include additional steps or features.

It should be understood that arrangements described herein are for purposes of example only. As such, those skilled in the art will appreciate that other arrangements and other elements (e.g. machines, interfaces, operations, orders, and groupings of operations, etc.) can be used instead of or in addition to the illustrated elements or arrangements.

### IV. EXPERIMENTAL RESULTS

A technique to render tactile feedback to the palmar side of the hand while keeping it unobstructed and, thus, preserving manual dexterity during interactions with physical objects was implemented and experimentally evaluated. In this experimental approach, there were no electrodes on the palmar side of the hand, yet that is where tactile sensations were felt. The electrodes were applied to locations outside the user's palm that conduct electrical currents to the median/ulnar nerves, inducing tactile sensations on the palmar side of the hand. In the studies described herein, this approach was able to render tactile sensations to at least 11 different locations on the palmar side of a user's hand while keeping the user's palm free for dexterous manipulations.

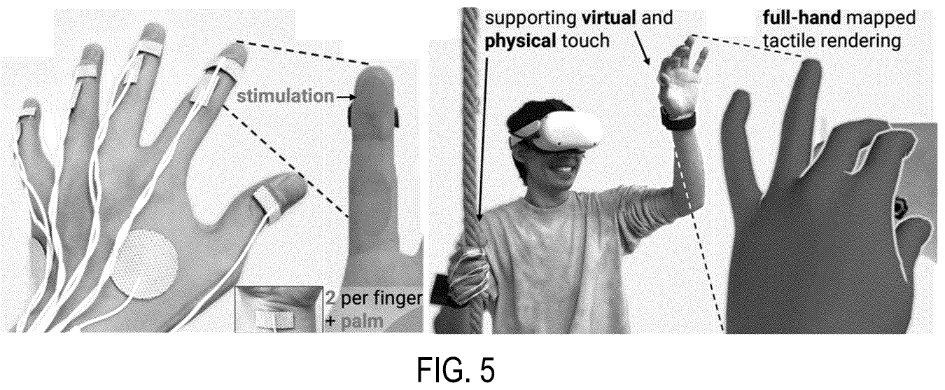

FIG. 5 depicts aspects of the evaluated technique for electro-tactile stimulation that creates touch sensations in 11 distinct locations on the palmar (or “front”) side of the hand without placing electrodes at the locations where those sensations are felt. The electrodes were placed in locations at the back (or “dorsal” side) of the hand and wrist, enabling the electrical currents to pass through the median/ulnar nerve, thus providing tactile feedback to the palmar side of the hand while keeping it free to interact with physical objects. Stimulation intensities that created sensations primarily on the palmar side, rather than the back side, of the hand were determined, leveraging the hand's dorsal vs. palmar tactile asymmetry. The polarity of the applied stimulation was also varied (anodic or cathodic) to increase the number of stimulated locations of the hand. The experimental data provided herein verify that the embodiments described herein can be employed to render tactile sensations in at least 11 distinct locations on the palmar side of the hand.

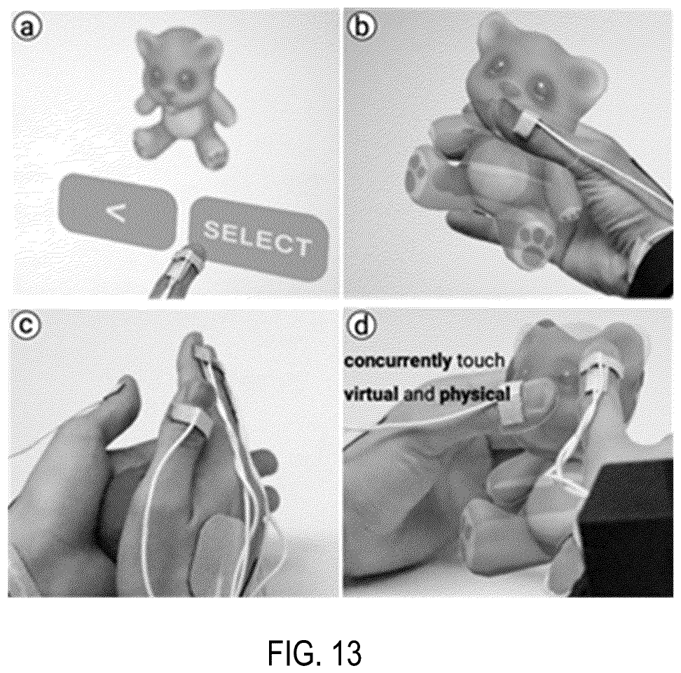

Providing such haptic feedback to the palm while keeping the palm free facilitates applications in which users can feel virtual tactile feedback while simultaneously touching and grasping physical objects; this was investigated and demonstrated using three applications: (1) integrating physical props in a VR bouldering experience (FIG. 5), (2) providing tactile notifications while DJing (FIG. 12), and (3) feeling both virtual & physical models in mixed reality (FIG. 13).

By stimulating nerves with electrical currents, the interface described herein can induce tactile sensations; this may be referred to as electro-tactile stimulation.

The embodiments described herein accomplish at least two goals: (1) rendering tactile sensations on multiple locations of the hand's palmar side, while simultaneously (2) preserving the tactile acuity of the same locations where the sensations are created. This was accomplished by electrically stimulating the palmar digital nerves (namely, the median and ulnar) using electrodes attached to the dorsal (i.e., back) side of the hand and the wrist.

Electrical currents can cause sensations in mechanoreceptors, even in those distant from the stimulated point—these may be referred to as “referred sensations.” It was experimentally determined that it is possible to cause sensations on the palmar side of the hand by selectively stimulating nerves anywhere between the hand and the brain (e.g., forearm, elbow, arm).

FIG. 1A illustrates how the digital (i.e., finger) nerves branch out for individual fingers after the wrist. As illustrated in FIGS. 1B and 1C, certain supra-threshold inter-electrode distances can stimulate palmar digital nerves without stimulating the dorsal digital nerves; otherwise, the current flow may be limited to stimulating the back side of the hand (dorsal digital nerves).

FIG. 1A shows the two main nerves directly connected to the mechanoreceptors on the palmar side of the hand. As illustrated, both nerves go through the forearm and then the wrist. At the wrist, these nerves connect directly to the palm. This allows the whole palm to be stimulated via electrodes at the wrist, using referred sensations to create similar sensations. However, more targeted stimulation cannot be accomplished using stimulation applied from outside the skin, as the nerves are too close to each other (bundled) at the wrist. This prevents (non-implanted) stimulation from evoking sensations in individual fingers without interference across fingers.

However, as shown in FIG. 1A, the nerves start branching out for the individual fingers after the wrist. Thus, the embodiments described herein act to stimulate the back of the hand distal to this branching point, where the nerves are separated, becoming easier targets for electrical stimulation.

FIG. 1B depicts a naïve approach of applying two electrodes (positive and negative) near each other directly atop a target location. However, the current flow between such electrodes is too shallow to stimulate palmar digital nerves and was only able to stimulate the dorsal side. This is because the closer two electrodes are together, the shallower the current penetrates into the tissue. However increasing the distance between the electrodes allows the current flow to also stimulate deeper regions. Indeed, it was experimentally determined that stimulation with a large inter-electrode distance, as depicted in FIG. 1C, was able to generate sensations on the palmar side of the hand.

To make the sensation on the palmar side more dominant than sensation on the dorsal side from such an electrode arrangement, the asymmetry in tactile sensitivity between the palmar and dorsal side of the hand was leveraged. This asymmetry is depicted in FIG. 2A. The palmar side has ˜60 times more mechanoreceptors(≈18000) than the dorsal side(≈300)—this may be related to the palmar side playing the more important role in dexterous manipulations.

The density of mechanoreceptors is correlated to the sensory threshold to electro-tactile stimulation. Thus, this asymmetry makes the dorsal side less sensitive to stimulation compared to the palmar side. A stimulation intensity was thus experimentally determined for each electrode that exceeded the sensory threshold of the palmar side while staying sub-threshold on the dorsal side. Thus, the feasibility of primarily stimulating the palmar side of the hand by adjusting the intensity of electro-tactile stimulation to this range was verified.

The electrode arrangement depicted in FIG. 2B was evaluated for its ability to create sensations in each finger segment, i.e., distal phalanx (i.e., fingerpad), middle phalanx, and proximal phalanx. Note that these electrodes 210a, 210b, 210c were paired with a return electrode attached further away on the back of the hand. This arrangement was observed to perform poorly for at least two reasons. Firstly, the proximal-phalanx electrode 210c was not able to cause a tactile sensation on the palmar side—this might be explained by the presence of a tendon layer (central slip) under the electrode location. Instead, it was found that the middle-phalanx electrode 210b created sensations on the palmar side of the proximal phalanx. This is because electrodes on the back of the finger create sensations on the palmar side of the finger that are offset, as depicted in FIG. 2B.

To obtain stimulation of the fingerpad, cathodic stimulation was used. Cathodic stimulation advances the location of the sensation in the distal (fingertip-ward) direction—the stimulation provided in the examples of FIGS. 2A and 2B was anodic. The electrode arrangement depicted in FIG. 2C was able, using cathodic stimulation, to stimulate the fingerpad from the back of the finger. Note that, in the example embodiment depicted in FIG. 2C, only two electrodes 220a, 220b were able to provide stimulation at three different locations on the palmar surface of the hand. The distal-phalanx electrode 220a was usable to stimulate the fingerpad and the middle-phalanx targets by switching between the cathodic and anodic stimulation. The proximal-phalanx electrode 220b was usable to stimulate the proximal-phalanx target using anodic stimulation. The thumb, having only two segments, was able to be serviced using one electrode on the distal phalanx operated in either cathodic or anodic mode.

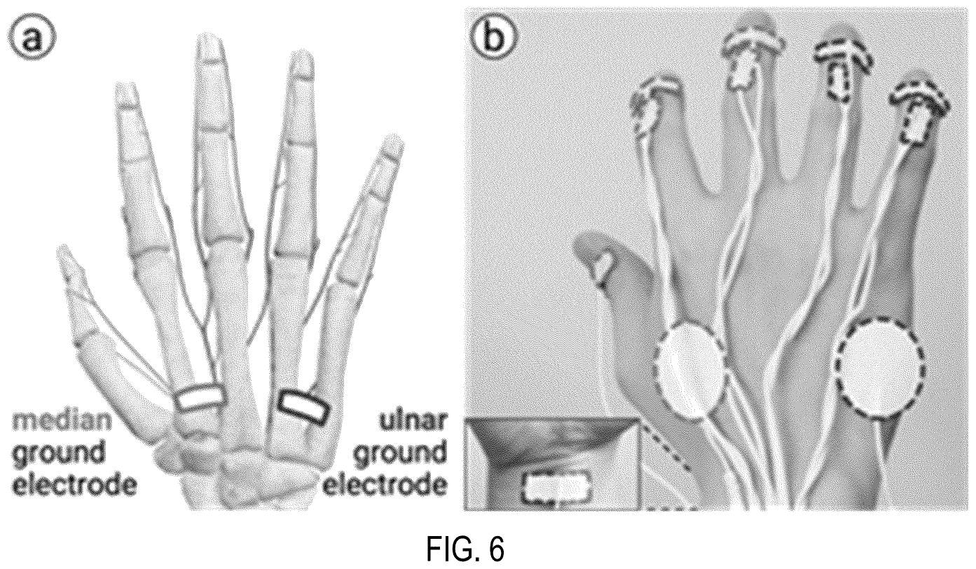

In some examples, such stimulation resulted in sensations not only in the target finger, but also unwanted tactile feedback in other fingers. Such interference may have an anatomical cause: FIG. 6(a) depicts how the median and ulnar nerves divide the left and right regions of the hand, i.e., the thumb, index, middle, and ring fingers are served by the median nerve and the ring and pinky fingers are served by the ulnar nerve. If an electrical current traverse the two nerves, it can cause sensations to be felt across multiple fingers. To reduce or prevent this interference, two return electrodes were applied to the back of the base of the hand, medially and laterally, that respectively served the median and ulnar nerves. By using one of the two returns at a time, depending on which nerve served the target finger, the currents primarily stimulated the targeted finger.

FIG. 6(b) depicts an example arrangement of an array of stimulation and return electrodes, which can create tactile sensations at up to 15 locations (one on the palm, two on the thumb, three on each of the index, middle, ring, and pinky fingers). Additional electrodes could be applied to the fingers and thumb (or to other areas of the hand) to provide stimulus to additional areas of the hand and/or to allow the distal-most electrodes of each finger/thumb to provide stimulus to only one area (by operating only in cathodic mode, rather than in both cathodic and anodic modes to provide stimulus to two different areas). However, such “middle” electrodes were found to exhibit more spatial variance (blurred sensations). Choosing locations that exhibited lesser spatial variance (more focused sensations) resulted in the arrangement of FIG. 6(b), allowing 11 locations of the user's palmar hand to be stimulated without placing a single electrode on the palmar side of the user's hand (neither the ‘base’ (palm) of the hand nor the palmar side of any of the fingers or thumb).

Most of the primary sensations were felt only on the palmar side of the hand (93.3%), though some primary sensations could also be felt on the back of the hand (6.7%).

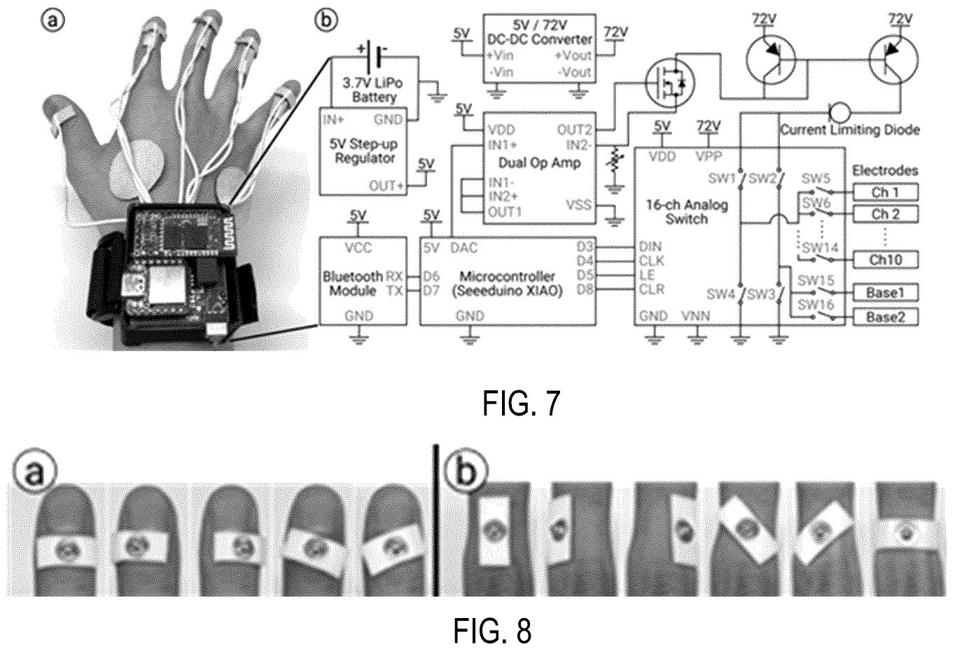

FIG. 7(a) depicts aspects of the experimental stimulator system, which was implemented as a wrist-worn electrotactile stimulator that was able to output currents to 10 polarity-switchable channels (i.e., cathodic/anodic stimulation). It measured 3.4 cm×4.6 cm×4.2 cm and weighed 34 g.

FIG. 7(b) depicts aspects of the electronics of the experimental system. The stimulator was powered using a 3.7 V LiPo battery, converted to 5 V by a step-up regulator (U1V11F5). This 5V powered the microcontroller (Seeeduino XIAO) and the Bluetooth module (HC-06). To generate the 72V voltage supply for electrical stimulation a 5V/72V DC-DC converter (NMT0572SC) was used.

When the microcontroller received a serial message from an application via Bluetooth, it responded by generating an analog signal using a built-in DAC; this 0-3.3V signal controlled the stimulation intensity. Using a 10-bit resolution DAC allowed the system to perform precise increments to fine-tune the tactile thresholds, which facilitated back-of-hand tactile stimulation of the palmar hand without also stimulating the dorsal hand. This DAC output was fed into a dual op-amp (LMV358) and a FET (BSS87) to output a load-independent current. Then, two transistors (FCX705) duplicated the current source, outputting it to an analog-switch IC (HV2701). The switch was used to direct the stimulation to a target pair of electrodes with a specified polarity: SW1-4 formed an h-bridge that dictated the stimulation polarity, while the states of SW5-16 decided which pair of electrodes output the stimuli. For instance, when stimulating the fingerpad of the index finger, the IC configured SW1, 3, 6, 15 to ON and all other switches to OFF—a cathodic stimulation between channel-2 and base-1 electrodes.

Off-the-shelf pre-gelled electrodes from Omron were employed, sized as follows: 1.1 cm² rectangular electrodes for the finger stimulation electrodes; 2.5 cm² rectangular electrodes for the wrist stimulation electrode; and 5 cm² electrodes for the return electrodes (“bases”).

For the fingerpads, cathodic currents were delivered to the electrodes at the distal phalanges. For the proximal phalanges and the palm, the device output anodic currents to the middle-phalanx and the wrist electrodes respectively.

A variety of application-specific haptic effects were evaluated using this experimental system. The following parameters for haptic effects were used: (1) for pressing MR buttons, a single 50-ms pulse was output; (2) for other touching or grasping interactions (e.g., touching a teddy bear or DJing), 100 Hz pulses with 400-s pulse width were used; and (3) for rendering the roughness of the bouldering pegs, 40 Hz pulses with 800-μs were used.

To mitigate interference across multiple channels, the switching IC only opened a current path for one target at a time. Since this IC was able to toggle between channels in 10 μs, the device completed a sequential cycle of single-pulses to all 11 targets within 10 ms. Since the temporal discrimination threshold of tactile stimuli is about 50 ms, this means the device was able to stimulate multiple targets “concurrently” in the user's perception, up to 100 Hz.

To ensure a safe operation, the variable resistor was adjusted to set the maximum current to 4 mA. As a fail-safe, a current limiting diode (E-452) was also added that shuts off currents over 4.5 mA.

MR/VR applications were implemented using a Quest 2 headset and Unity3D. The headset also tracked the user's hands. For the VR bouldering simulator, a VR hand physics simulator was used to make the virtual hands compliant when touching virtual objects. For the MR clay modeling application, Quest's PassThrough API was used. For the DJ application, the backend was implemented using Max/MSP and the front-end used MIXXX (a DJ application that supports Digital Vinyl System, allowing DJs to play digital audio via turntables). To decode the timecode information stored on the digital vinyl record xwax was used to extract the current speed and position of a record. These implementations compared these outputs to the metadata saved for a number of records (which DJs save using MIXXX, including the original BPM, cue points, and so forth). This was used to determine when to render an electro-tactile cue, for example, when the current record position matches any saved cue point.

The location(s) where participants perceived tactile feedback on their hands was investigated. All 15 possible locations were stimulated via electrodes on the back of the hand. In each trial, one location was stimulated, then participants were asked to denote the skin area where they felt the stimulation and its strongest point.

Ten participants were recruited (7 identified as male, 3 as female, average age=23.9 years, SD=2.5). All participants were right-handed.

Participants sat at a desk with their non-dominant hands resting on a cushioned arm stand with the stimulator and electrodes connected. To ensure good conductivity, conductive gel was applied on the electrodes. An iPad and Apple pencil was provided so that participants could draw (with their dominant hand) to indicate the perceived sensation area on a GUI, which depicted both a palmar side and dorsal side of a hand model.

Square wave stimulation was used with the polarities described above (i.e., cathodic for the distal-phalanges and anodic for all other sites).

To avoid bias, instead of running calibration before trials, trials were conducted with multiple electrode adjustments per participant and data from the best (i.e., calibrated) electrode adjustment was used.

The techniques described herein were determined to work with fixed electrode locations, e.g., electrodes were placed within the finger segments. However, while coarse location calibration was not needed, minor adjustment of the electrode position and orientation within the finger segments was sometimes indicated. Thus, the following electrode adjustments, depicted in FIG. 8, were evaluated: (a) five adjustments for the distal phalanges and (b) six adjustments for the middle phalanges. The wrist and the return (“ground”) electrodes were determined not to need adjustment.

Each participant performed 75 trials in a randomized order: all 15 targets in all aforementioned electrode adjustments. At the beginning of each trial, the intensity was calibrated by increasing the current amount in 0.1 mA steps while verifying that it was pain-free (the maximum current limit was set to 4 mA). Stimulation was stopped at the intensity where participants noticed any tactile sensation. This intensity+0.1 mA was then used to ensure participants could clearly perceive the stimulation without experiencing pain (after calibrating all participants, an average intensity of 1.85 mA, SD=0.8 was observed). After a random waiting period, the device output ten 50-ms pulses spaced by one second. During stimulation, the interface reminded participants to move their hand between two poses: resting on the desk and staying in mid-air; this allowed participants to feel stimuli in both skin-contact and non-contact conditions. Finally, the participant indicated the point where the sensation was the strongest and the area where the sensation occurred on the GUI. At the end of the trials for each target, the responses were organized by distance from the strongest point to the center of the target area.

To analyze data based on calibrated electrode adjustments, the response with the smallest distance was selected.

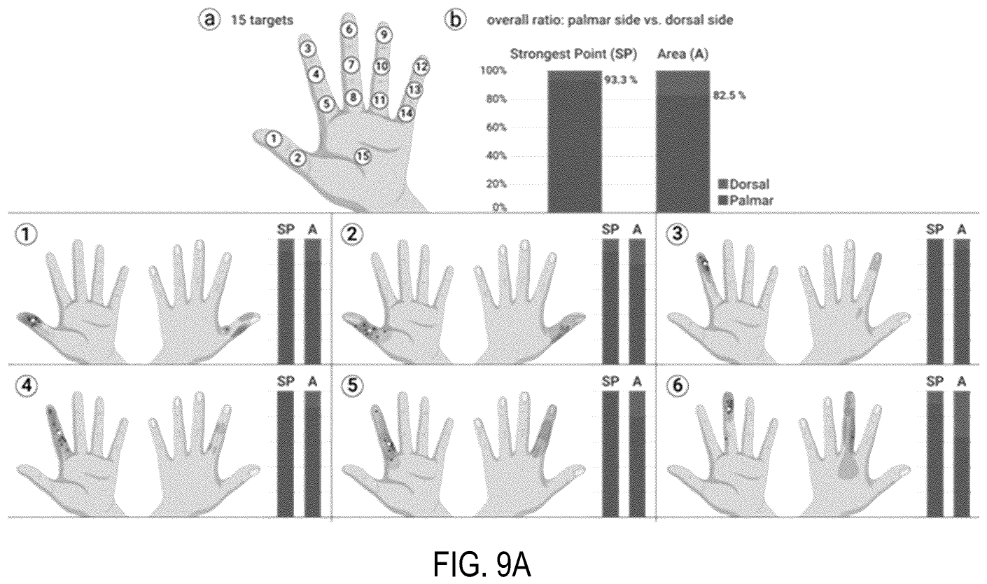

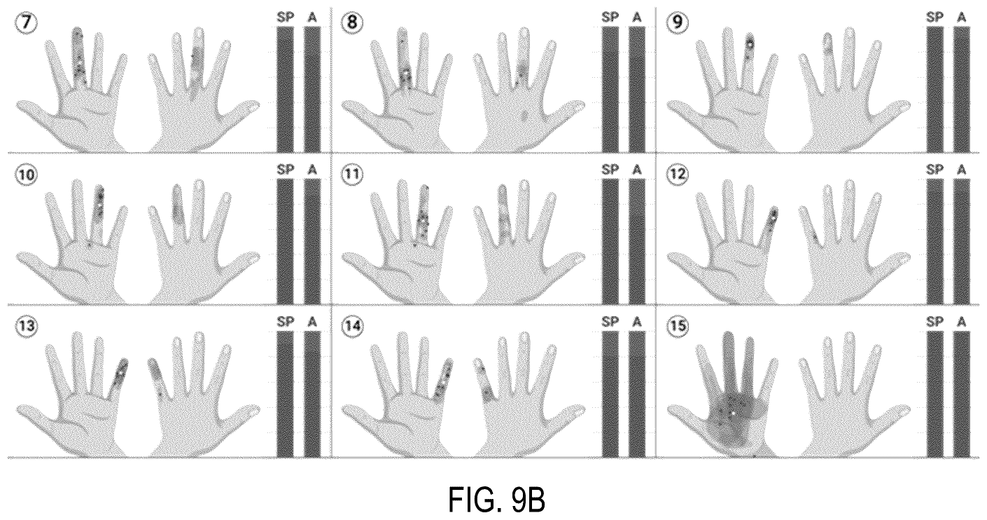

As shown in FIGS. 9A-B, in aggregate, 93.3% of points where the strongest sensation was felt occurred on the palmar side, despite the electrodes being attached to the dorsal side and the wrist. The stimulated area was 82.5% on the palmar side (SD=13.41%). The majority of unwanted (dorsal) sensation was reported only for the middle and pinky fingers. For all participants, the strongest points for the index, middle, and palm were always on the palmar side. On average participants felt strongest points on the palmar side for 14 out of 15 targets (SD=1.63; minimum=11; maximum=15).

FIG. 9A-B (a) shows the 15 target locations on the palmar side of the hand to elicit tactile sensation via our back-of-hand electro-tactile stimulation. FIG. 9A-B (b) shows the overall ratio of the tactile sensation elicited on the palmar vs. dorsal side. FIG. 9A-B (1-15) show overlaid raw data for all participants; black points correspond to strongest points; white points are averages; colored shades depict the area indication.

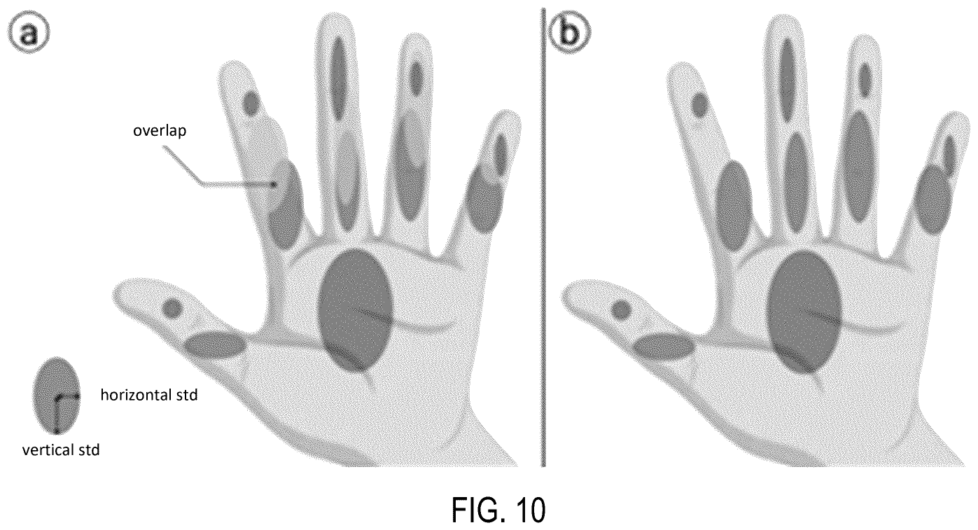

FIG. 9A-B (1-15) also depicts the average location (white dot), per target, where sensations were felt. FIG. 10(a) summarizes results for all 15 locations: each ellipse depicts the center of the average location and the horizontal/vertical standard deviations of all strongest points on the palmar side for each target. Overall, the distal-phalanx (fingerpad) targets had smaller deviations than the others. As depicted in FIG. 10(b), a clear spatial separation (i.e., the standard deviations did not overlap with each other) existed between finger segments when the middle-phalanx segments were excluded, which tended to overlap primarily with the proximal phalanges (FIG. 10(a)).

Overall, the approach described herein created tactile sensations mostly on the user's palmar side of the hand, not the dorsal side. This approach rendered an unprecedented number of distinctive points—the 11 tactile locations depicted in FIG. 10(b).

The unencumbering tactile feedback provided by the embodiments described herein facilitates a variety of applications, including some not possible before, for instance: (1) VR climbing with haptic props; (2) DJ'ing with tactile notifications; and (3) modeling clay in mixed reality.

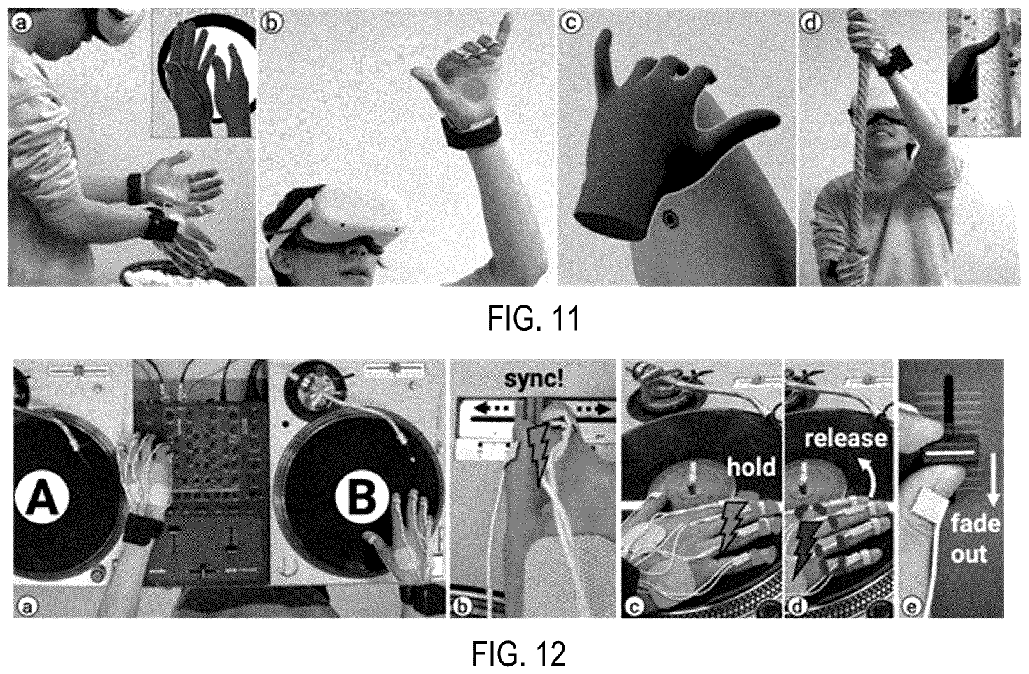

Using physical props that stand in for virtual objects is a popular technique to yield higher haptic realism in virtual environments. However, typically, this approach is employed when users are not wearing any haptic wearable devices, such as vibration gloves, because most haptic devices would impair the user's ability to manipulate and feel the rich tactile feedback from the props. The techniques described herein can alleviate this as they allow users to feel both physical props as well virtual feedback. As shown in FIG. 11(a), the user is in a VR bouldering simulator and before climbing the wall, they put chalk onto their hands. The experimental device did not encumber the user's palms while rubbing the real chalk, which acts as a physical prop to enhance immersion.

While climbing, they feel electro-tactile stimulation at the locations where their hands touch the bouldering pegs—in fact, FIG. 11(b) shows how the user's thumb and pinky are not touching the peg and thus do not experience feedback; this depicts how the approach herein is selective at the level of individual finger segments.

This VR climbing experience was furnished with another prop, a climbing rope attached to a pulley in the ceiling. As depicted in FIG. 11(d), the user was able to grab the rope and feel its texture, or even apply force on it, without any encumbrance from the system's electrodes.

In the DJ application, the tactile feedback approach described herein supported a DJ's performance without encumbering their hands' dexterity (e.g., placing the vinyl onto the turntable, manipulating the mixer, “scratching” the record). As depicted in FIG. 12(a), the user was DJ'ing, attempting to mix the two turntable decks (A and B) together, by matching their tempo. DJs that use Digital Vinyl Systems (e.g., the popular Serato, which allows playing digital audio using traditional turntables) rely on visual information in their laptops for mixing. Instead, the DJ in the depicted experiment used electro-tactile notifications.

First, the DJ adjusted the tempo of deck B by moving the turntable's pitch slider. When the tempo is in sync with that of deck A, the tactile feedback to the fingers holding the slider notified the user, as depicted in FIG. 12(b). Now that deck B was at the correct tempo, the used attempted to find the cue point to fade deck B into the main mix. Again, DJs that use Digital Vinyl Systems must look at their laptop screen and move the record until it hits the desired cue point. Instead, the DJ in this study was able to focus on the turntables, relying on electro-tactile notifications. As depicted in FIG. 12(c), the user moved deck B's record back and forth, searching for the cue point, which the system described herein rendered as an electro-tactile sensation under the fingerpads that held the record—thus indicating the physical cue point. Finally, a DJs must release the record at the cue point, on time. As shown in FIG. 12(d), the DJ waited for electro-tactile feedback to the proximal phalanges (close to palm) that indicated to release deck B. Both tunes were then being played in sync and the DJ faded deck A using the mixer's fader, as depicted in FIG. 12(e). Note this performance was accomplished without encumberment from the system's electrodes.

Systems described herein were evaluated to guide a user as they modeled physical shapes in mixed reality (MR) using real clay. FIG. 13(a) depicts the user pushing MR buttons to browse through 3D models to choose which model they wanted the system to assist them with—as they pressed buttons, they felt electro-tactile feedback to confirm the actions and add realism to the interactions.

The user then chose the bear model and attempted to clay a copy of it. To understand the model's geometry, the user could touch, grasp, move, and rotate the virtual bear with their whole hand. As they did so, the system rendered each of the 11 possible palm segments that were in contact with the 3D model, feeling on the whole hand as they grabbed the model as shown in FIG. 13(b). Then, as depicted in FIG. 13(c), the user molded the clay, putting force on their palm and fingerpads—since the electrodes were attached to the back of the hand and the wrist, they provided minimal encumberment. Finally, to give the finishing touches to the clay bear's head, the user aligned the physical and real model and used electro-tactile stimulation to feel the places where the VR model differed from the clay model, as depicted in FIG. 13(d).

### V. CONCLUSION

It should be understood that arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

We claim:

1. A method, comprising:
applying a set of electrodes to a wearer, wherein applying the set of electrodes comprises applying a first stimulation electrode to dorsal skin of a first finger of a hand of the wearer and applying a first return electrode to skin of the wearer; and
applying stimulation through the first stimulation electrode, using the first return electrode as a counter electrode, sufficient to induce a perceivable haptic stimulus in palmar skin of the first finger of the hand without inducing a perceivable haptic stimulus in dorsal skin of the first finger of the hand.

2. The method of claim 1, wherein applying the first return electrode to skin of the wearer comprises applying the first return electrode to dorsal skin of a base of the hand of the wearer.

3. The method of claim 2, wherein the first finger is served by an ulnar nerve of the wearer, and wherein the applying the first return electrode to dorsal skin of a base of the hand of the wearer comprises applying the first return electrode to dorsal skin of a lateral region of the base of the hand of the wearer, and wherein applying the set of electrodes further comprises applying a second stimulation electrode to dorsal skin of a second finger of the hand of the wearer and applying a second return electrode to dorsal skin of a medial region of the base of the hand of the wearer, wherein the second finger is served by a median nerve of the wearer.

4. The method of claim 3, further comprising:
applying stimulation through the second stimulation electrode, using the second return electrode as a counter electrode, sufficient to induce a perceivable haptic stimulus in palmar skin of the second finger of the hand without inducing a perceivable haptic stimulus in dorsal skin of the second finger of the hand.

5. The method of claim 1, wherein applying stimulation through the first stimulation electrode comprises providing cathodic stimulation sufficient to induce a perceivable haptic stimulus in palmar skin of the first finger of the hand at a first location on the first finger that is distal to the first stimulation electrode.

6. The method of claim 5, further comprising:
applying additional stimulation through the first stimulation electrode by providing anodic stimulation sufficient to induce a perceivable haptic stimulus in palmar skin of the first finger of the hand at a second location on the first finger that is proximal to the first stimulation electrode.

7. The method of claim 6, wherein applying the set of electrodes further comprises applying a second stimulation electrode to dorsal skin of the first finger at a location that is proximal to the first stimulation electrode, and wherein the method further comprises:
applying stimulation through the second stimulation electrode sufficient to induce a perceivable haptic stimulus in palmar skin of the first finger of the hand at a third location on the first finger that differs from the second location.

8. The method of claim 1, wherein applying stimulation through the first stimulation electrode comprises providing stimulation sufficient to induce a perceivable haptic stimulus in palmar skin of the first finger of the hand at a first location on the first finger, wherein applying the set of electrodes further comprises applying a second stimulation electrode to dorsal skin of the first finger at a location that is proximal to the first stimulation electrode, and wherein the method further comprises:
applying stimulation through the second stimulation electrode sufficient to induce a perceivable haptic stimulus in palmar skin of the first finger of the hand at a second location on the first finger that differs from the first location.

9. The method of claim 8, wherein applying stimulation through the first stimulation electrode comprises providing cathodic stimulation such that the first location is distal to the first stimulation electrode, and wherein applying stimulation through the second stimulation electrode comprises providing anodic stimulation such that the second location is proximal to the second stimulation electrode.

10. The method of claim 1, further comprising:
providing a variety of different magnitudes of stimulation through the first stimulation electrode;
based on providing the variety of different magnitudes of stimulation through the first stimulation electrode, determining (i) a first minimum magnitude of stimulation to induce a perceivable haptic stimulus in palmar skin of the first finger of the hand and (ii) a second minimum magnitude of stimulation to induce a perceivable haptic stimulus in dorsal skin of the first finger of the hand; and
determining a default stimulus magnitude for the first stimulation electrode that is greater than the first minimum magnitude and less than the second minimum magnitude, wherein applying stimulation through the first stimulation electrode sufficient to induce a perceivable haptic stimulus in palmar skin of the first finger of the hand without inducing a perceivable haptic stimulus in dorsal skin of the first finger of the hand comprises applying stimulation of the default stimulus magnitude through the first stimulation electrode.

11. The method of claim 1, wherein applying the set of electrodes further comprises applying a second stimulation electrode to skin of the wrist of the hand, and wherein the method further comprises:
applying stimulation through the second stimulation electrode sufficient to induce a perceivable haptic stimulus in palmar skin of the palm of the hand.

12. The method of claim 11, wherein applying the set of electrodes further comprises (i) applying an additional stimulation electrode to dorsal skin of the first finger, (ii) applying two additional stimulation electrodes to each of the other three fingers and thumb of the hand, and (iii) applying a second return electrode to dorsal skin of a medial region of the base of the hand of the wearer, and wherein applying the first return electrode to skin of the wearer comprises applying the first return electrode to dorsal skin of a lateral region of the base of the hand of the wearer.

13. The method of claim 1, further comprising:
detecting a position and a configuration of the hand;
determining, based on the detected position and configuration of the hand, a simulated degree of contact between a simulated object and the palmar skin of the first finger of the hand, wherein applying the stimulation through the first stimulation electrode comprises providing the stimulation at a magnitude based on the simulated degree of contact.

14. A system, comprising:
a first stimulation electrode configured to be applied to dorsal skin of a first finger of a hand of a wearer;
a first return electrode configured to be applied to skin of the wearer;
a stimulus generator operably coupled to the first stimulation electrode and the first return electrode; and
a controller configured to operate the stimulator to apply stimulation through the first stimulation electrode, using the first return electrode as a counter electrode, sufficient to induce a perceivable haptic stimulus in palmar skin of the first finger of the hand without inducing a perceivable haptic stimulus in dorsal skin of the first finger of the hand.

15. The system of claim 14, wherein the first finger is served by an ulnar nerve of the wearer, wherein the first return electrode is configured to be applied to dorsal skin of a lateral region of a base of the hand of the wearer, and wherein the system further comprises:
a second stimulation electrode configured to be applied to dorsal skin of a second finger of the hand of the wearer, wherein the second finger is served by a median nerve of the wearer; and
a second return electrode configured to be applied to dorsal skin of a medial region of the base of the hand of the wearer
and wherein the controller is additionally configured to operate the stimulator to apply stimulation through the second stimulation electrode, using the second return electrode as a counter electrode, sufficient to induce a perceivable haptic stimulus in palmar skin of the second finger of the hand without inducing a perceivable haptic stimulus in dorsal skin of the second finger of the hand.

16. The system of claim 14, wherein operating the stimulator to apply stimulation through the first stimulation electrode comprises operating the stimulator to provide cathodic stimulation sufficient to induce a perceivable haptic stimulus in palmar skin of the first finger of the hand at a first location on the first finger that is distal to the first stimulation electrode.

17. The system of claim 16, wherein the controller is additionally configured to operate the stimulator to apply additional stimulation through the first stimulation electrode by providing anodic stimulation sufficient to induce a perceivable haptic stimulus in palmar skin of the first finger of the hand at a second location on the first finger that is proximal to the first stimulation electrode.

18. The system of claim 17, further comprising:
a second stimulation electrode configured to be applied to dorsal skin of the first finger at a location that is proximal to the first stimulation electrode, wherein he controller is additionally configured to operate the stimulator to apply stimulation through the second stimulation electrode sufficient to induce a perceivable haptic stimulus in palmar skin of the first finger of the hand at a third location on the first finger that differs from the second location.

19. The system of claim 14, wherein operating the stimulator to apply stimulation through the first stimulation electrode comprises providing cathodic stimulation sufficient to induce a perceivable haptic stimulus in palmar skin of the first finger of the hand at a first location on the first finger that is distal to the first stimulation electrode, and wherein the system further comprises:
a second stimulation electrode configured to be applied to dorsal skin of the first finger at a location that is proximal to the first stimulation electrode, wherein the controller is additionally configured to operate the stimulator to apply anodic stimulation through the second stimulation electrode sufficient to induce a perceivable haptic stimulus in palmar skin of the first finger of the hand at a second location on the first finger that is proximal to the second stimulation electrode.

20. The system of claim 14, further comprising:
a second stimulation electrode configured to be applied to dorsal skin of the first finger, wherein the first finger is served by an ulnar nerve of the wearer;
a third stimulation electrode configured to be applied to skin of the wrist of the hand;
eight additional stimulation electrodes configured to be applied two to each of the other three fingers and thumb of the hand; and
a second return electrode configured to be applied to dorsal skin of a medial region of the base of the hand of the wearer, wherein the first return electrode is configured to be applied to dorsal skin of a lateral region of the base of the hand of the wearer, wherein the controller is additionally configured to operate the stimulator to apply stimulation through a stimulation electrode of the eight additional electrodes that is configured to be applied to a second finger of the hand, using the second return electrode as a counter electrode, sufficient to induce a perceivable haptic stimulus in palmar skin of the second finger of the hand without inducing a perceivable haptic stimulus in dorsal skin of the second finger of the hand, and wherein the second finger is served by a median nerve of the wearer.
